(19) United States
(12) Patent Application Publication
(10) Pub. No.: US 2016/0162920 A1
(43) Pub. Date: Jun. 9, 2016

(54) SYSTEMS AND METHODS FOR PURCHASING PRICE SIMULATION AND OPTIMIZATION

(71) Applicants: Johann Kemmer, Muehlhausen (DE); Martina Rothley, Schwetzingen (DE)

(72) Inventors: Johann Kemmer, Muehlhausen (DE); Martina Rothley, Schwetzingen (DE)

(21) Appl. No.: 14/560,727

(22) Filed: Dec. 4, 2014

(51) Int. Cl. G06Q 30/02

(52) U.S. Cl. CPC G06Q 30/0206

(57) ABSTRACT

The present disclosure is generally directed to systems and methods for simulating the cost of goods and/or services, and triggering procurement events based upon the simulated pricing. The systems and methods receive historic price data including purchasing volumes for the product(s) and/or service(s) that an organization procures in their normal course of business, anonymize the historic pricing data for each of the plurality of distinct organizational entities in order to generate aggregated historic pricing data, receive one or more procurement requests from a procurement system of the organization, calculate price predictions for goods and/or services based on information stored in an account database, identify one or more time periods and/or quantities for procuring requested goods and/or services, generate one or more procurement triggers indicating preferred period(s) for acquiring goods and/or services, and transmit the trigger(s) to the procurement system and/or an end user.

### BACKGROUND

The present disclosure generally relates to systems and methods for simulating pricing information for a variety of goods and/or services, and more particularly, to electronic applications that trigger procurement events based upon the simulated pricing.

The cost of various raw materials, products, and/or services is critical for businesses seeking to maximize profits. In particular, businesses struggle with determining the appropriate point(s) in time to execute procurement decisions. For example, economic patterns may influence the costs of goods and services at particular points in time. If the economy weakens, companies of all sizes may more aggressively seek lower cost solutions. As a result, prices for goods and services may be reduced.

In light of the increasingly competitive global marketplace, companies will continue to strive to reduce the cost for goods and services. This is especially true for high volume and expensive goods and services. As a result, there is a strong demand to simulate procurement costs of high volume and expensive goods and services so that financial resources may be preserved.

Organizations frequently utilize simulation systems to analyze business data and provide additional quantitative information that can be used in decision making. Unfortunately, these systems cannot be applied to procurement decisions for many goods and services. To assist with procurement decisions, businesses often turn to industry knowledge and their own experience to manage procurement functions. One approach that is often taken is to group products and services by category (e.g., legal, accounting, logistics, materials, etc.). Here, different individuals may be responsible for procurement decisions within each category.

To date, price simulation tools are limited to publicly traded commodities (e.g., gold, copper, silver, oil, etc.). Accordingly, the embodiments of the present disclosure promote the use of price simulation across a wider array of goods and/or services.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 illustrates a system level architecture that depicts the interaction between a price simulation system and a procurement system according to an example embodiment of the present disclosure.

FIG. 2 illustrates a method for procurement optimization according to an example embodiment of the present disclosure.

FIG. 3 illustrates a method for procurement optimization according to another example embodiment of the present disclosure.

FIG. 4 illustrates a representative architecture of a portable electronic device according to an example embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of the present disclosure are generally directed to systems and methods for simulating the cost of goods and/or services, and triggering procurement events based upon the simulated pricing. The embodiments include systems and methods that receive historic price data (including purchasing volumes) for the products) and/or service(s) that an organization procures in their normal course of business, anonymize the data received from the organization, receive one or more procurement requests from a procurement system of the organization, calculate price predictions for goods and/or services based on information stored in an account database, identify one or more time periods and/or quantities for procuring requested goods and/or services, generate one or more procurement triggers indicating preferred period(s) for acquiring goods and/or services, and transmit the trigger(s) to the procurement system and/or an end user.

The described systems and methods utilize several types of information that include, but are not limited to, historical pricing including costs and quantities, procurement requests, anonymized pricing information of other organizations (e.g., competitors), industry specific information (e.g., trends or cycles), and the like. Businesses can utilize the price simulation system and associated applications to access local and remotely stored information. Within, the price simulation system, a price simulation engine analyzes these data to provide the expected cost per unit for one or more goods and/or services in a certain timeframe given. For example, the expected cost per unit may be determined by the procurement system by the demand/supply situation over time.

Embodiments of user interfaces and associated methods for using a device are described. In some embodiments, the device is a portable communication device (e.g., a mobile phone or tablet). The user interface may include a touchscreen and/or other input/output devices. In the discussion that follows, a portable communications device is used as an example embodiment. It should be understood, however, that the user interfaces and associated methods may be applied to other devices, such as personal computers and laptops, which may include one or more other physical user-interface devices, such as a keyboard and/or mouse.

The portable communication device may support a variety of applications, such as telephone, text messenger, and procurement applications. The various applications that may be executed on the device may use at least one common physical user-interface device, such as a touchscreen. One or more functions of the touchscreen as well as corresponding information displayed on the device may be adjusted and/or varied from one application to another and/or within a respective application. In this way, a common physical architecture of the device may support a variety of applications with user interfaces that are intuitive and transparent. In the discussion that follows, a procurement application is used as an example embodiment, but it should be understood that the user interfaces and associated methods may be applied to other applications.

A user viewing a procurement application may vary its display and contents. Using a user-interface of the portable communication device, a user may change the selected good and/or service or its respective provider to compare the cost for each alternative. In the case of a touchscreen, the display may be changed by dragging or otherwise manipulating the displays illustrated on the touchscreen.

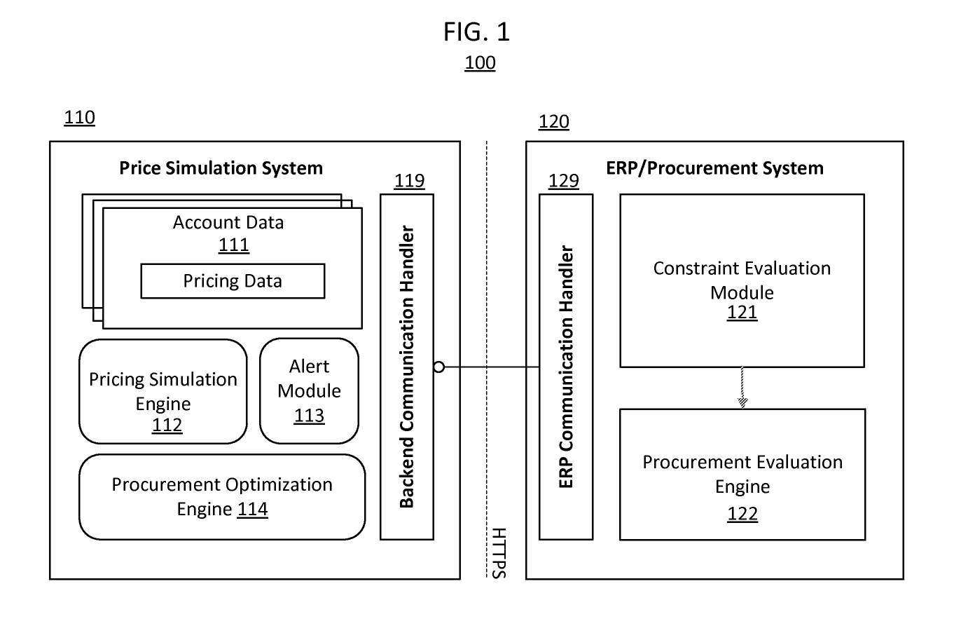

FIG. 1 illustrates a system level architecture that depicts the interaction between a price simulation system and a procurement system according to an example embodiment of the present disclosure.

As shown in FIG. 1, the system 100 includes a price simulation system 110 that is connected to a procurement system 120. The price simulation system 110 may include one or more account database(s) 111, price simulation engine 112, alert module 113, procurement optimization engine 114, and backend communication handler 119. The procurement system 120 may include constraint evaluation module 121, procurement evaluation engine 122, and ERP communication handler 129. Example procurement systems 120 may be included within larger systems such as enterprise resource planning (ERP) systems, customer relationship management (CRM) systems, business warehouse (BW) systems, and global supplier networks (e.g., Ariba), etc.

The price simulation system 110 may be connected to procurement system 120 using known or expected network technologies, including wired or wireless networks. Example network technologies include Internet, Intranet, wireless local area networks (WLAN), and/or wireless wide area networks (WWAN), and the like. Backend communication handler 119 and ERP communication handler 129 manage communications functions for the price simulation system 110 and procurement system 120, respectively.

The price simulation system 110 may be a standalone server, or may be integrated within a larger ERP, CRM, or BW system. For example, a dedicated price simulation system for use by a single organization may be located within the organization's Intranet and integrated with other network components. By contrast, a shared price simulation system accessible by multiple unaffiliated organizations may be hosted by a service provider giving access to the price simulation system via a web portal positioned in the Internet's demilitarized zone (DMZ).

Within price simulation system 110, one or more account databases 111 store several types of information such that historical price data is maintained. For example, account database(s) 111 may include a data store for prices/costs structured by product, product category, service, service category, and the like. In some implementations, the historic sales data stored in account database(s) 111 may classify entries according to international classification schemata such as global trade item number (GTIN) and/or European article number (EAN).

In some instances, account database(s) 111 may maintain historical procurement information for one or multiple organizations. In other words, the account database(s) 111 may utilize organization-internal purchasing documents (e.g., invoices, sales orders, quotations, etc.) or cross-organization pricing information. When procurement information is maintained for a plurality of organizations, especially non-affiliated business entities, the procurement information may be anonymized. In some embodiments, companies utilizing the price simulation system 110 to forecast pricing for particular goods and/or services may be obligated (e.g., contractually) to upload historic price data including purchasing volumes for those products and/or services. In addition, organizations may acquire rights to access different levels of information (e.g., depending on their subscription or level of contribution for historic pricing data). In the various embodiments, procurement information may be presented as industry, geographic, or customer specific.

Price simulation system 110 may further include price simulation engine 112. The price simulation engine 112 calculates price predictions for goods and/or services based on information stored in account database(s) 111. In some embodiments, the price simulation engine 112 may utilize one or more forecasting algorithms to predict future costs for various goods and/or services. Alternatively, or in addition, future price trends may be simulated using the anonymized purchasing patterns of participating organizations. In yet another alternative, aging and/or weighting functions may be applied to the historic pricing data such newer purchases are given more weight than older purchases when predicting future prices. Here, each sales entry stored in account database(s) 111 may include a timestamp indicating the closure date for the transaction.

Using historical price information stored in account database(s) 111 and predicted price information generated by price simulation engine 112, procurement optimization engine 114 may analyze the aggregated information to identify one or more time periods and/or quantities for procuring a variety of goods and/or services. In some instances, the procurement optimization engine 114 may also utilize one or more procurement request(s) generated by the procurement evaluation engine 122 of the procurement system 120. Also, the procurement optimization engine 114 may evaluate price simulations generated by 112 as well as constraints received from the procurement system 120 in order to satisfy procurement requests in light of the demand/supply situation over time. Alternatively, the procurement optimization engine 114 may reside in the procurement system 120 and rely upon information transferred from the price simulation system 110, depending upon the implementation. In addition, different algorithms may be used for each good or service.

After executing the various algorithms, the procurement optimization engine 114 generates one or more procurement triggers indicating preferred or optimal period(s) for acquiring requested goods and/or services. In other words, each trigger may include one or more suggested purchase orders. The triggers may be relayed to procurement system 120 and/or end user(s) by alert module 113 and communication handler 119. Triggers may be generated for initial and/or replenishment orders. End users may receive notifications from alert module 113 using a variety of communications technologies, such as e-mail, short message service (SMS), and the like.

In some instances, the suggested purchase orders contained within procurement triggers may be displayed and reviewed by an end user. For example, an end user may receive suggested purchase orders on a portable electronic device. In addition, the end user may manipulate a procurement application on the portable electronic device to change the suggested purchase orders. Such changes may be stored locally and/or transmitted to the price simulation system 110 and procurement system 120.

Within the procurement system 120, a constraint evaluation module 121 verifies that procurement requests generated by the procurement evaluation engine 122 are feasible. For example, if a certain amount of a particular product is being requested, the constraint evaluation module 121 may determine whether an organization's storage warehouse has adequate storage space to contain the potential product order. In this example, the constraint evaluation module 121 may automatically adjust the quantity to the maximum possible or provide an error message to an end user. In another example, the constraint evaluation module 121 may determine whether the organization has adequate funding to purchase the potential product order. Again, the constraint evaluation module 121 may automatically adjust the quantity to the maximum possible or provide an error message to an end user.

Procurement requests are stored within the procurement evaluation engine 122. Procurement requests may be automatically generated or manually inputted by an end user of the procurement system 120. For example, an end user may input procurement requests using a procurement application executed on a portable electronic device. In another example, an initial order may be manually input by an end user whereas a replenishment order may be automatically generated if inventory of a particular product is below a predetermined threshold. In yet another example, the end user may vary procurement requests in order to either run further price simulations or to influence the result calculated by the procurement optimization engine 114.

As can be understood, the disclosed example price simulation system 110 calculates the optimal periods in time and quantities for purchasing the requested product(s) and/or service(s). In addition, the use of purchase triggers enable organizations to achieve a combination of lower costs while maintaining supply demand needs.

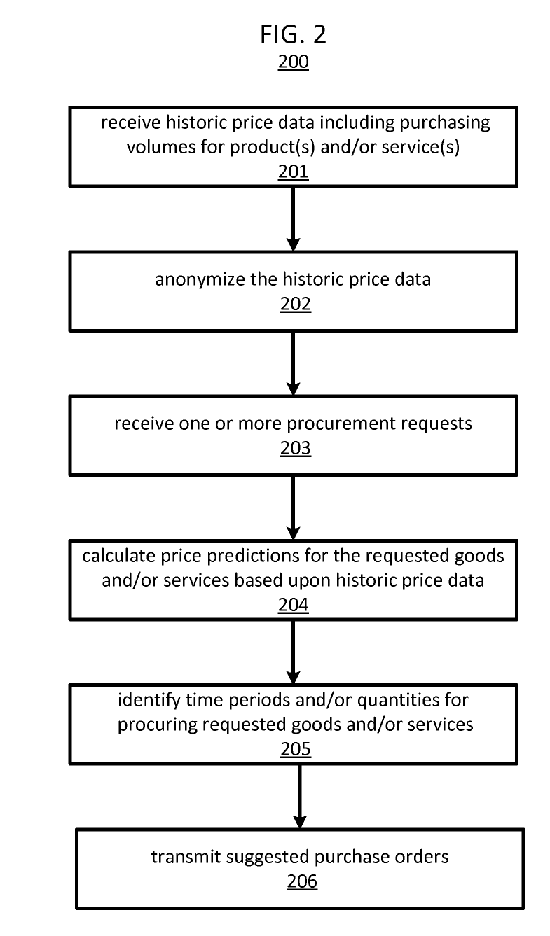

FIG. 2 illustrates a method 200 for procurement optimization according to an example embodiment of the present disclosure.

At 201, the price simulation system 110 may receive historic price data including purchasing volumes for the product(s) and/or service(s) that an organization procures in their normal course of business. Historic price information may be received initially upon the organization's registration with the price simulation system 110 and periodically thereafter. In some instances, an organization may identify multiple product(s) and/or service(s) of interest when registering.

At 202, the price simulation system 110 may anonymize the historic price data received from the organization. Historic price data is may be anonymized if the price simulation system 110 maintains historic price data for multiple entities. For example, historic price data may be anonymized during inbound processing. In addition, a statistical record may be generated to indicate the number of records transferred from each organization together with a timestamp in order to track each organization's contributions.

Next, at 203, the price simulation system 110 may further receive one or more procurement requests from a procurement system 120 of the organization. The procurement request may have a variety of formats, but may identify a product or service, volume, and target price. For example, a procurement request may identify a specific quantity of a certain material and a latest delivery date or a delivery time frame depending on the organization's supply demand constraints as calculated by the procurement system 120.

At 204, the price simulation engine 112 of price simulation system 110 calculates price predictions for the requested goods and/or services based upon information stored in account database(s) 111. As discussed above, the price simulation engine 112 may utilize one or more forecasting algorithms to predict future costs for various goods and/or services.

Next, at 205, the procurement optimization engine 114 identifies one or more time periods and/or quantities for procuring requested goods and/or services. In addition, the procurement optimization engine 114 may generate one or more procurement triggers indicating preferred period(s) for acquiring goods and/or services. Lastly, at 206, the trigger(s) (e.g., suggested purchase orders) may be transmitted to the procurement system 120 and/or end user(s) by alert module 113 and backend communication handler 119.

The method depicted in FIG. 2 may be implemented beginning at the time the organization registers to utilize the price simulation system 100. In addition, the price simulation system 110 may store the organization's account and geographic location in order to provide information catered to a specific organization.

After registration, access to the price simulation system 110 may require various security techniques and/or credentials. For example, an end user may be required to supply a login name and login password. The login name and login password may then be used to identify individual end users associated with a registered procurement system 120. In addition, secured communications may be adopted to enable communication between the price simulation system 110 and the procurement system 120.

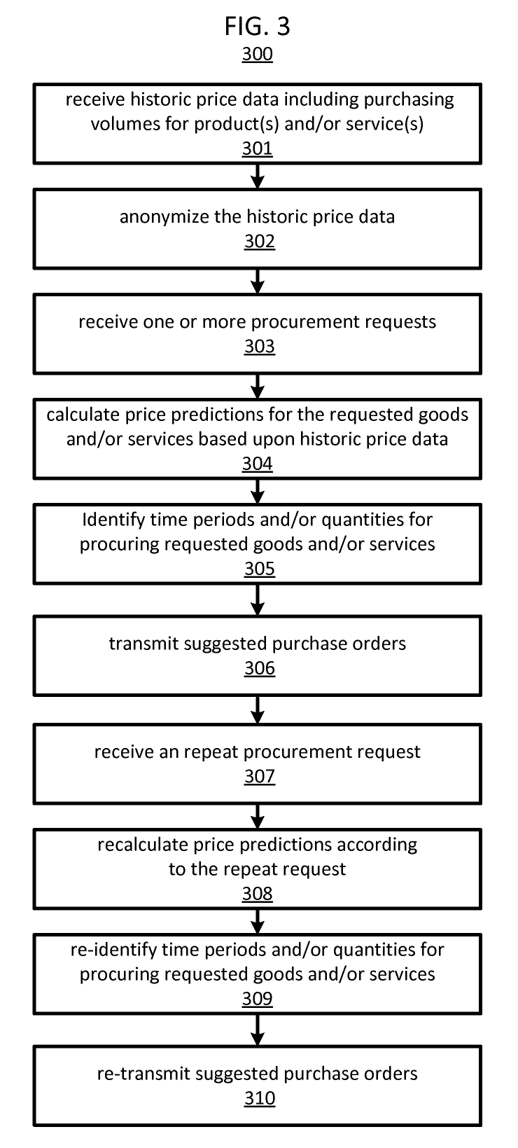

FIG. 3 illustrates a method 300 for procurement optimization according to another example embodiment of the present disclosure.

At 301, the price simulation system 110 may receive historic price data including purchasing volumes for the product(s) and/or service(s) that an organization procures in their normal course of business. Historic price information may be received initially upon the organization's registration with the price simulation system 110 and periodically thereafter. In some instances, an organization may identify multiple product(s) and/or service(s) of interest when registering.

At 302, the price simulation system 110 may anonymize the historic price data received from the organization. Next, at 303, the price simulation system 110 may further receive one or more procurement requests from a procurement system 120 of the organization.

At 304, the price simulation engine 112 of price simulation system 110 calculates price predictions for goods and/or services based upon information stored in account database(s) 111. As discussed above, the price simulation engine 112 may utilize one or more forecasting algorithms to predict future costs for various goods and/or services.

Next, at 305, the procurement optimization engine 114 identifies one or more time periods and/or quantities for procuring requested goods and/or services. In addition, the procurement optimization engine 114 may generate one or more procurement triggers indicating preferred period(s) for acquiring goods and services. At 306, the trigger(s) may be transmitted to the procurement system 120 and/or end user(s) by alert module 113 and backend communication handler 119.

At step 307, the price simulation system 110 receives a repeat procurement request. Here, the procurement system 120 may call the price simulation system 110 multiple times for the same product or service request. For example, in case that the price simulation system predicts a declining price in the requested timeframe, multiple requests may be used in order to detect the best possible price minimum. Alternatively, a repeat procurement request may be initiated based upon changing demands.

Upon receiving the repeat procurement request, the price simulation engine 112 may recalculate price predictions according to the repeat request based upon information stored in account database(s) 111, at 308. Next, at 309, the procurement optimization engine 114 re-identifies one or more time periods and/or quantities for procuring the goods and/or services identified in the repeat procurement request. In addition, the procurement optimization engine 114 may generate additional procurement trigger(s) indicating preferred period(s) for acquiring goods and/or services. Lastly, at 310, the trigger(s) may be transmitted to the procurement system 120 and/or end user(s) by alert module 113 and backend communication handler 119.

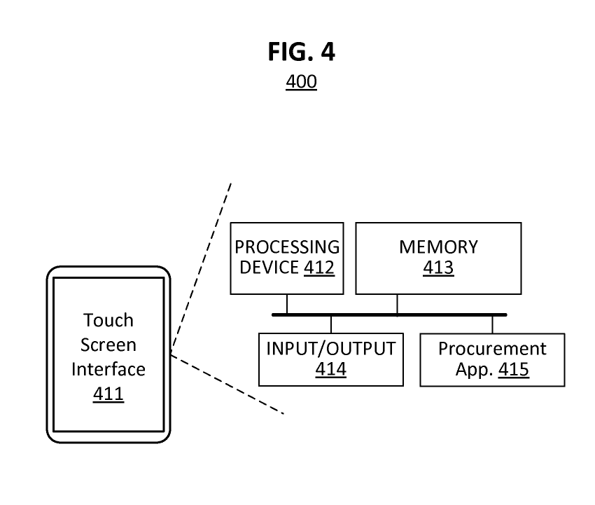

FIG. 4 illustrates a representative architecture of a portable electronic device according to an example embodiment of the present disclosure.

A portable electronic device 400 may include a touchscreen interface 411, processing device 412, memory 413, and input/output module 414. The touchscreen interface 411 may include a display, which may be a touchscreen, capable of displaying data to a user of the portable electronic device 400. Portable electronic device 400 may also include a procurement application module 415 that interfaces with the price simulation system 110 and procurement system 120 via a communication handler (not shown).

Although not shown, the touchscreen may also include a sensor that may be a capacitive touch detection sensor, configured to detect and track movement on the surface and/or in the vicinity of the display. The sensor may be coupled to a signal processing circuit that is configured to identify, locate, and/or track object movement(s) based upon the data obtained from the sensor.

Memory 413 may include a computer readable medium storing application modules, which may include instructions associated with applications and modules of the portable electronic device 400. In an example embodiment, memory 413 may contain different components for retrieving, presenting, changing, and saving data and may include computer readable media. Memory 413 may include a variety of memory devices, for example, Dynamic Random Access Memory (DRAM), Static RAM (SRAM), flash memory, cache memory, and other memory devices. Additionally, for example, memory 413 and processing device(s) 412 may be distributed across several different computers that collectively comprise a system. Memory 413 may be capable of storing user inputs and preferences as well as changes to purchase orders. In some instances, a cache in memory 413 may store a user's changes to the suggested purchase order generated by price simulation system 110.

The input/output module 414 manages the functionality of touchscreen interface 411. For example, input/output module 414 may include functionality for identifying a touched point(s) within the procurement application displaying a potential purchase order. Purchase order(s) may be submitted and/or modified by manipulating the display of the portable electronic device 400.

The portable electronic device 400 may contain a processing device 412, memory 413, and a communications handler (not shown), all of which may be interconnected via a system bus. In various embodiments, the portable electronic device 400 may have an architecture with modular hardware and/or software systems that interfaces with additional and/or different systems and devices communicating through one or more networks via the communications handler.

The communications handler may enable connectivity between the portable communication device 400 and other systems or devices. For example, the communications handler may encode data to be sent from the processing device 412 to another system over a network and decode data received from another system over the network for the processing device 412.

Processing device 412 may perform computation and control functions of a system and comprises a suitable central processing unit (CPU). Processing device 412 may include a single integrated circuit, such as a microprocessing device, or may include any suitable number of integrated circuit devices and/or circuit boards working in cooperation to accomplish the functions of a processing device. Processing device 412 may execute computer programs, such as the procurement application and other object-oriented computer programs, stored within memory 413.

The foregoing description has been presented for purposes of illustration and description. It is not exhaustive and does not limit embodiments of the disclosure to the precise forms disclosed. For example, although the processing device 412 is shown as separate from the modules 414 and 415 and the touchscreen interface 411, in some instances the processing device 412 and the touch screen interface 411 and/or one or more of the modules 414 and 415 may be functionally integrated to perform their respective functions.

It will be apparent to those skilled in the art that various modifications and variations can be made in the systems and methods for purchasing price simulation and optimization of the present disclosure without departing from the spirit or scope of the disclosure. Thus, it is intended that the present disclosure cover the modifications and variations of this disclosure provided they come within the scope of the appended claims and their equivalents.

We claim:

1. A method comprising:
receiving historic pricing data for a procurement object from a plurality of distinct organizational entities;
anonymizing the historic pricing data for each of the plurality of distinct organizational entities in order to generate aggregated historic pricing data;
storing aggregated historic pricing data within a database;
receiving a procurement request from one of the plurality of distinct organizational entities, the procurement request identifying the procurement object;
in response to the procurement request, calculating a predicted price for the procurement object using the aggregated historic pricing data; and
generating a suggested purchase order based upon fluctuations to the predicted price for the procurement object.

2. The method of claim 1, further comprising:
transmitting the suggested purchase order to a user; and
receiving a modified purchase order in response to changes to the suggested purchase order.

3. The method of claim 1, wherein an aging factor is applied to each entry of the aggregated historic pricing data.

4. The method of claim 1, wherein the procurement object is associated with an international classification schemata.

5. The method of claim 1, further comprising:
periodically receiving historic pricing data for the procurement object from the plurality of distinct organizational entities.

6. The method of claim 1, wherein the procurement object is one of a raw material, product, and service.

7. The method of claim 1, wherein the procurement object is one of a raw material and a product, and the procurement request further includes a quantity and target delivery date.

8. A non-transitory computer readable storage medium storing one or more programs configured to be executed by a processor, the one or more programs comprising instructions for:
receiving historic pricing data for a procurement object from a plurality of distinct organizational entities;
anonymizing the historic pricing data for each of the plurality of distinct organizational entities in order to generate aggregated historic pricing data;
storing aggregated historic pricing data within a database;
receiving a procurement request from one of the plurality of distinct organizational entities, the procurement request identifying the procurement object;
in response to the procurement request, calculating a predicted price for the procurement object using the aggregated historic pricing data; and
generating a suggested purchase order based upon fluctuations to the predicted price for the procurement object.

9. The computer readable storage medium of claim 8, further comprising:
transmitting the suggested purchase order to a user; and
receiving a modified purchase order in response to changes to the suggested purchase order.

10. The computer readable storage medium of claim 8, wherein an aging factor is applied to each entry of the aggregated historic pricing data.

11. The computer readable storage medium of claim 8, wherein the procurement object is associated with an international classification schemata.

12. The computer readable storage medium of claim 8, further comprising:
periodically receiving historic pricing data for the procurement object from the plurality of distinct organizational entities.

13. The computer readable storage medium of claim 8, wherein the procurement object is one of a raw material, product, and service.

14. The computer readable storage medium of claim 8, wherein the procurement object is one of a raw material and a product, and the procurement request further includes a quantity and target delivery date.

15. A price simulation server comprising:
one or more processors; and
memory storing one or more programs for execution by the one or more processors, the one or more programs including instructions for:
anonymizing the historic pricing data for each of the plurality of distinct organizational entities in order to generate aggregated historic pricing data;
storing aggregated historic pricing data within a database;
receiving a procurement request from one of the plurality of distinct organizational entities, the procurement request identifying the procurement object;
in response to the procurement request, calculating a predicted price for the procurement object using the aggregated historic pricing data; and
generating a suggested purchase order based upon fluctuations to the predicted price for the procurement object.

16. The price simulation server of claim 15, further comprising:
transmitting the suggested purchase order to a user; and
receiving a modified purchase order in response to changes to the suggested purchase order.

17. The price simulation server of claim 15, wherein an aging factor is applied to each entry of the aggregated historic pricing data.

18. The price simulation server of claim 15, wherein the procurement object is associated with an international classification schemata.

19. The price simulation server of claim 15, further comprising:
periodically receiving historic pricing data for the procurement object from the plurality of distinct organizational entities.

20. The price simulation server of claim 15, wherein the procurement object is one of a raw material, product, and service.

21. The price simulation server of claim 15, wherein the procurement object is one of a raw material and a product, and the procurement request further includes a quantity and target delivery date.
